(19) United States
(12) Patent Application Publication
(10) Pub. No.: US 2026/0111010 A1
(43) Pub. Date: Apr. 23, 2026

(54) MULTIAGENT SYSTEM

(71) Applicants: TOYOTA JIDOSHA KABUSHIKI KAISHA, Toyota-shi Aichi-ken (JP); Toyota School Foundation, Nagoya-shi Aichi-ken (JP)

(72) Inventors: Satoshi KIKUCHI, Susono-shi Shizuoka-ken (JP); Takumi MOTOORI, Nagoya-shi Aichi-ken (JP); Michihiro KAWANISHI, Nagoya-shi Aichi-ken (JP)

(73) Assignees: TOYOTA JIDOSHA KABUSHIKI KAISHA, Toyota-shi Aichi-ken (JP); Toyota School Foundation, Nagoya-shi Aichi-ken (JP)

(21) Appl. No.: 19/347,178

(22) Filed: Oct. 1, 2025

(30) Foreign Application Priority Data
Oct. 18, 2024 (JP) 2024-184454

(51) Int. Cl. G05B 19/418

(52) U.S. Cl. CPC G05B 19/41865

(57) ABSTRACT

A multiagent system includes a plurality of agents, a plurality of first controllers that controls the agents, respectively, and a plurality of second controllers that performs cooperative control among the agents. The number of dimensions of an input/output vector that is input to the agents is a first number of dimensions. The agents include a first gain that transforms the input/output vector of the first number of dimensions into an input/output vector of a second number of dimensions. The first number of dimensions is a total count of a plurality of buffers that is included in a production process to which the multiagent system is applied. The second number of dimensions is determined by a count of elements that are objects of control input by the agents of the first controllers.

### CROSS-REFERENCE TO RELATED APPLICATION

This application claims priority to Japanese Patent Application No. 2024-184454 filed on Oct. 18, 2024, incorporated herein by reference in its entirety.

### BACKGROUND

### 1. Technical Field

The present disclosure relates to a multiagent system.

### 2. Description of Related Art

Conventionally, multiagent systems made up including a plurality of agents are known (Japanese Unexamined Patent Application Publication No. 2021-005257 (JP 2021-005257 A), Japanese Unexamined Patent Application Publication No. 2021-005256 (JP 2021-005256 A), Japanese Unexamined Patent Application Publication No. 2003-233599, (JP 2003-233599 A), Japanese Unexamined Patent Application Publication No. 2022-074019 (JP 2022-074019 A)).

### SUMMARY

There is demand for further improvements in multiagent systems.

In view of the above, an object of the present disclosure is to improve multiagent systems.

A multiagent system according to one embodiment of the present disclosure includes a plurality of agents, a plurality of first controllers that controls the agents, respectively, and a plurality of second controllers that performs cooperative control among the agents, in which in the multiagent system in which number of dimensions of an input/output vector that is input to the agent is a first number of dimensions, the agents include a first gain that transforms the input/output vector of the first number of dimensions into an input/output vector of a second number of dimensions, the first number of dimensions is a total count of a plurality of buffers that is included in a production process to which the multiagent system is applied, and the second number of dimensions is determined by a count of elements that are objects of control input by the agents of the first controllers.

According to one embodiment of the present disclosure, a multiagent system can be designed such that the multiagent system is improved.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram illustrating a flow of a production process;

FIG. 2 is a diagram illustrating an example of a configuration of a multiagent system;

FIG. 3 is a diagram illustrating a logic model of an agent;

FIG. 4 is a diagram illustrating a logic model of an agent according to a comparative example;

FIG. 5 is a diagram illustrating a configuration of a multiagent system according to the comparative example;

FIG. 6 is a diagram illustrating another example of a configuration of a multiagent system;

FIG. 7 is a schematic diagram illustrating a flow of a production process that is used in simulation;

FIG. 8 is a diagram illustrating a logical model of an agent used in simulation; and

FIG. 9 is a diagram showing simulation results.

### DETAILED DESCRIPTION OF EMBODIMENTS

An embodiment of the present disclosure will be described below with reference to the drawings.

### Overview of Production Process

First, a production process to which a multiagent system of the present disclosure can be applied will be described.

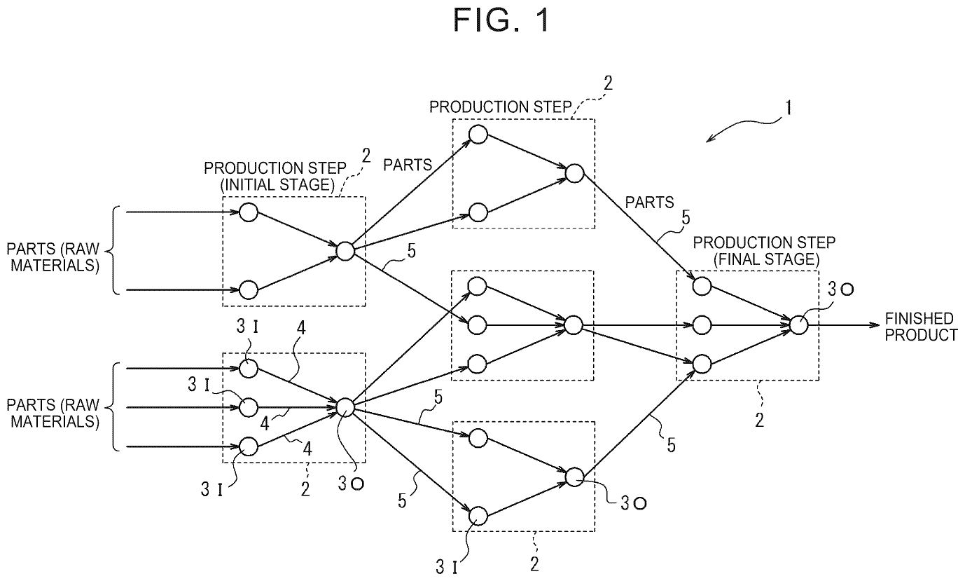

A production process 1 such as illustrated in FIG. 1 is a compilation of steps from input of parts such as raw materials or the like, to production of a finished product. In the production process 1, one or a plurality of production steps 2 are involved between the supply of parts, such as raw materials, and the production of the finished product. That is to say, the production process 1 includes one or multiple production steps 2.

The production step 2 includes at least one input buffer 3I, one output buffer 3O, and at least one step 4. A step 4 is interposed between the input buffer 3I and the output buffer 3O. The production step 2 and a production step 2 downstream therefrom are connected via a transporting step 5. The term “downstream” refers to a direction toward the finished product in the flow from parts such as raw materials being supplied in the production process 1 to the finished product being produced. Upstream is an opposite direction to downstream.

Parts such as raw materials are externally supplied to the input buffers 3I of an initial stage production step 2. The input buffers 3I of production steps 2 other than the initial stage are supplied with parts that are produced in upstream production steps 2 therefrom. The supplied parts are temporarily stocked in the input buffers 3I.

In the production steps 2 other than a final stage, one or a plurality of the steps 4 uses parts that are supplied from one or a plurality of the input buffers 3I to produce products that will become parts that are supplied to downstream production steps 2. In a final stage production step 2, one or multiple steps 4 produce finished products using parts that are supplied from one or a plurality of the input buffers 3I.

A product that is a finished product is output from the output buffer 3O of the final stage production step 2. Products that will become parts to be supplied to the production step 2 downstream therefrom are output from the output buffer 3O of each production step 2 other than the final stage. In the output buffer 3O, products that are produced in one or multiple steps 4 are temporarily stocked.

The transporting steps 5 connect the output buffers 3O of the production steps 2 other than the final stage with the input buffers 3I of the downstream production steps 2 therefrom. The parts output from the output buffers 3O are transported via the transporting steps 5 to the input buffers 3I.

### Configuration of Multiagent System

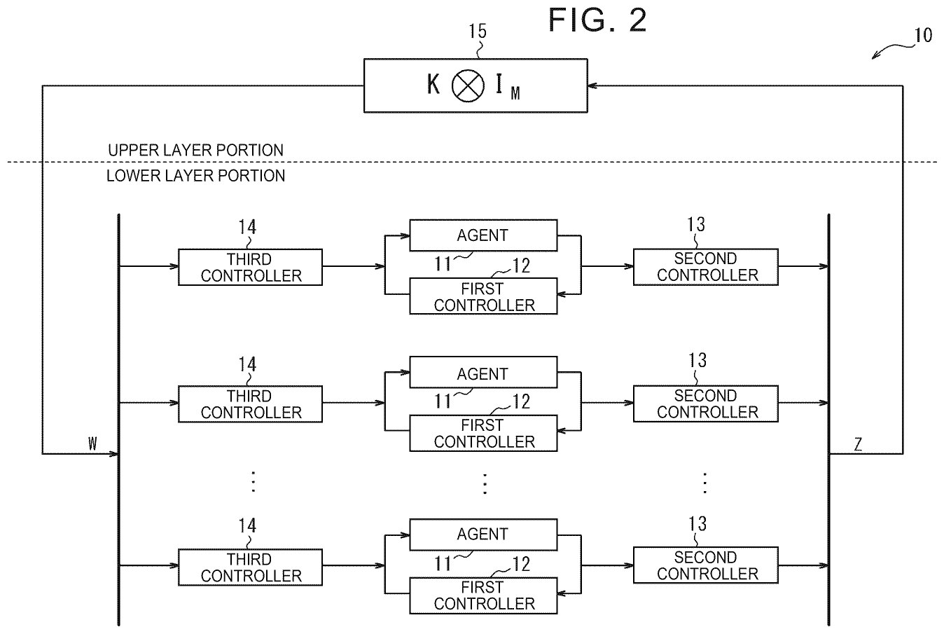

FIG. 2 illustrates a multiagent system 10 according to the present embodiment. This multiagent system 10 has a hierarchical structure, and employs distributed control. The multiagent system 10 may be referred to as a “distributed control system”.

The multiagent system 10 can be applied to the production process 1 as illustrated in FIG. 1. By applying the multiagent system 10 to the production process 1, production volume of products in each production step 2 and transportation volume of products in transporting steps 5 such as illustrated in FIG. 1 can be independently controlled.

The multiagent system 10 has an upper layer portion and a lower layer portion as the hierarchical structure. The multiagent system 10 includes, at the lower layer portion thereof, a plurality of agents 11, a plurality of first controllers 12, a plurality of second controllers 13, and a plurality of third controllers 14. The multiagent system 10 includes a connector 15 at the upper layer portion.

The agents 11 correspond to the production steps 2 in the production process 1 such as illustrated in FIG. 1. The agents 11 are, for example, control devices or the like in the production steps 2. The control devices in the production steps 2 are, for example, robots.

The first controllers 12 are made up including at least one processor, at least one dedicated circuit, or a combination thereof. The processor is, for example, a general-purpose processor such as a central processing unit (CPU), a graphics processing unit (GPU), or the like, or a dedicated processor that is specialized for particular processing. The dedicated circuit is, for example, a field-programmable gate array (FPGA), an application-specific integrated circuit (ASIC), or the like. The first controllers 12 may each include a storage unit. The storage unit may store various types of information, programs, and so forth. The storage unit may be made up of semiconductor memory or the like, for example. The storage unit may function as work memory for the first controllers 12.

The first controllers 12 control the agents 11. The first controllers 12 controls the agents 11 to control production volume of the products in the production steps 2 corresponding to the agents 11. The first controllers 12 are also referred to as “local controller”.

The second controllers 13 are made up including at least one processor, at least one dedicated circuit, or a combination thereof. The processor is, for example, a general-purpose processor such as a CPU, a GPU, or the like, or a dedicated processor that is specialized for particular processing. The dedicated circuit is, an FPGA, an ASIC, or the like, for example. The second controller 13 may each include a storage unit. The storage unit may store various types of information, programs, and so forth. The storage unit may be made up of semiconductor memory or the like, for example. The storage unit may function as work memory for the second controller 13.

The second controllers 13 perform cooperative control among the agents 11. The second controllers 13 control transport volume of products in the transporting steps 5. The second controllers 13 are also referred to as “global controller”.

The third controllers 14 are made up including at least one processor, at least one dedicated circuit, or a combination thereof. The processor is, for example, a general-purpose processor such as a CPU, a GPU, or the like, or a dedicated processor that is specialized for particular processing. The dedicated circuit is, an FPGA, an ASIC, or the like, for example. The third controllers 14 may each include a storage unit. The storage unit may store various types of information, programs, and so forth. The storage unit may be made up of semiconductor memory or the like, for example. The storage unit may function as work memory for the third controllers 14.

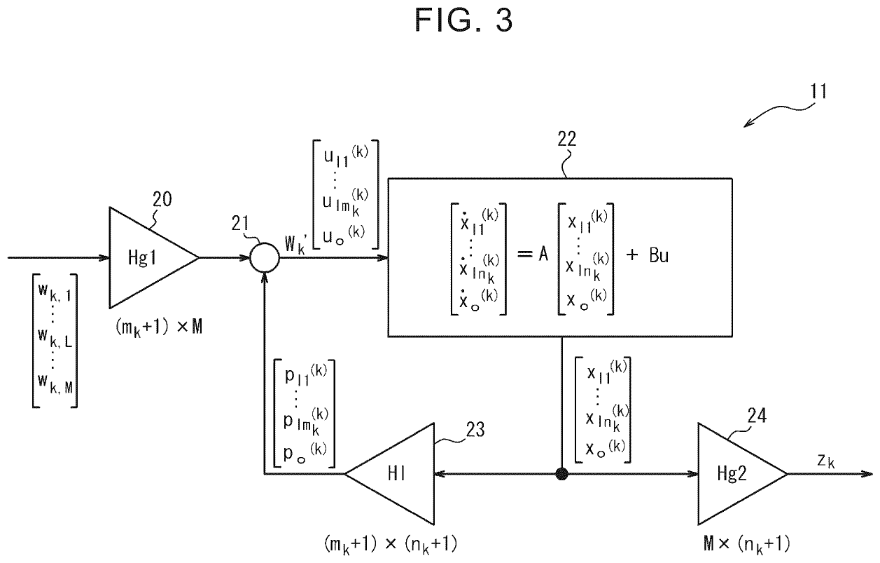

The third controller 14 controls a first gain 20, as illustrated in FIG. 3, which will be described later.

An input/output vector Z is input to the connector 15. The input/output vector Z is a vector that indicates the input/output of the agents 11. The input/output of the agents 11 corresponds to one or multiple input buffers 3I and one output buffer 3O that are included in the production step 2 corresponding to the agents 11.

The input/output vector Z is given, for example, by Expression (1).

$$Z = {( {Z}_{1}^{T} , … , {Z}_{k}^{T} , … , {Z}_{N}^{T} )}^{T} \qquad ( 1 )$$

In Expression (1), integer N (1≤N) is the total number of the agents 11 that are included in the multiagent system 10. The subscript k (1≤k≤N) indicates the k′th agent 11 from among the N agents 11. Hereinafter, the number of input buffers 3I that are included in the production step 2 corresponding to the k′th agent 11 will be written as “nₖ”.

Element Zₖ^{T} of the input/output vector Z is given by the following Expression (2).

$${Z}_{k} = {d}_{k} \cdot {{Z}_{O}}^{( k )} \qquad ( 2 )$$

In Expression (2), the subscript k satisfies 1≤k≤N. Furthermore, element Z_{O}^{(k)} of Expression (2) is given by Expression (3). Vector dₖ is given by Expression (4).

$${Z}_{O}^{( k )} = {H}_{g 2} \cdot {x}_{O}^{( k )} \qquad ( 3 )$$

$${d}_{k} = {( {d}_{k , 1} , … , {d}_{k , L} , … , {d}_{k , M} )}^{T} \qquad ( 4 )$$

In Expression (3), coefficient H_{g2} is a constant. Element x_{O}^{(k)} indicates a state of stock of the product in the output buffer 3O^{(k)} that is included in the production step 2, equally or similarly to Expression (13) described later.

In Expression (4), integer L satisfies 1≤L≤M. The integer M is the total number of the input buffers 3I and output buffers 3O that are included in the production process 1. The integer M is given by Expression (5). Also, element d_{k,L} of Expression (4) is given by the following Expression (6).

$$\begin{matrix}[ Math . 1 ] & \\ M = {\sum }_{k = 1}^{N} {n}_{k} + N & ( 5 )\end{matrix}$$

$$\begin{matrix}[ Math . 2 ] & \\ {d}_{k , L} = \{ \begin{matrix}0 , case where output buffer 3 {O}^{( k )} does not connect to ( match ) buffer 3 {B}_{L} \\ 1 , case where output buffer 3 {O}^{( k )} connects to ( matches ) buffer 3 {B}_{L}\end{matrix} & ( 6 )\end{matrix}$$

In Expression (6), the output buffer 3O^{(k)} is the output buffer 3O of the production step 2 corresponding to the k′th agent 11. Buffer 3B_{L} is the total number of the input buffers 3I and the output buffers 3O that are included in the production process 1, which is to say, the L′th buffer 3B among the M count of buffers 3B when the input buffer 3I and the output buffer 3O are described as “buffer 3B” without distinguishing therebetween. Note however, that when the i′th input buffer 3I; (k) (where 1≤k≤N, 1≤i≤nₖ) of the production step 2 corresponding to the k′th agent 11 is the L′th input buffer 3I_{L}, then the input buffer 3Iᵢ^{(k)}=buffer 3B_{L}. Also, the integer L in this case is given by the following Expression (7).

$$\begin{matrix}[ Math . 3 ] & \\ L = {\sum }_{j = 1}^{k - 1} {n}_{j} + i & ( 7 )\end{matrix}$$

In Expression (7), integer j is an integer that satisfies 1≤j≤k−1.

The connector 15 transforms the input/output vector Z into an input/output vector W, and provides the input/output vector W with connectivity relations among the production steps 2 through the transporting steps 5 as illustrated in FIG. 1. In this embodiment, the connector 15 transforms the input/output vector Z into the input/output vector W using a Laplacian matrix K that represents a connectivity relation based on graph theory. The Laplacian matrix K is a weighted Laplacian matrix that represents the connectivity relation among the production steps 2 by a plurality of the transporting steps 5 as illustrated in FIG. 1. Here, the input/output vector Z is a vector with number of dimensions MN (the number of dimensions MN is the product of the integer M and an integer N). Therefore, the connector 15 calculates the input/output vector W by multiplying the input/output vector Z by a matrix that is calculated by the Kronecker product of the Laplacian matrix K and an identity matrix IM. The identity matrix IM is an M×M identity matrix.

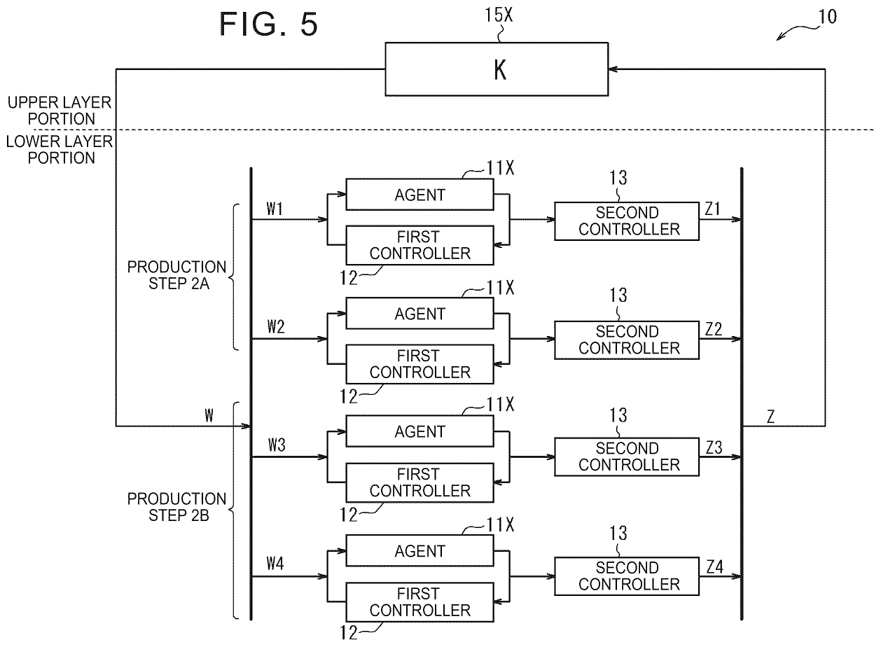

For example, in the case of production steps 2A and 2B illustrated in FIG. 5, which will described later, the Laplacian matrix K is given by Expression (8).

$$\begin{matrix}[ Math . 4 ] & \\ K = [ \begin{matrix}{H}_{g 2} + {H}_{l 1} & - {H}_{l 1} & 0 & - {H}_{g 2} \\ - {H}_{l 1} & {H}_{g 2} + {H}_{l 1} & - {H}_{g 1} & 0 \\ 0 & - {H}_{g 1} & {H}_{g 2} + {H}_{l 2} & - {H}_{l 2} \\ - {H}_{g 2} & 0 & - {H}_{l 2} & {H}_{g 2} + {H}_{l 2}\end{matrix} ] & ( 8 )\end{matrix}$$

$${H}_{l 1} = {H}_{l 2} = 0.02 , {H}_{g 1} = {H}_{g 2} = 0.03$$

The input/output vector W that is output from the connector 15 is given by Expression (9).

$$W = {( {W}_{1}^{T} , … , {W}_{k}^{T} , … , {W}_{N}^{T} )}^{T} \qquad ( 9 )$$

Element Wₖ of the input/output vector W in Expression (9) is given by Expression (10). This element Wₖ is input to the first gain 20 of the k′th agent 11, as illustrated in FIG. 3, which will be described later.

$${W}_{k} = {( {W}_{k , 1} , … , {W}_{k , L} , … , {W}_{k , M} )}^{T} \qquad ( 10 )$$

The integer M in Expression (10) is given by Expression (5) above. The integer L is an integer that satisfies 1≤L≤M.

Now, the number of dimensions M of the input/output vector Zₖ and the input/output vector Wₖ is the integer M. As described above, the integer M is the same as the total number of the input buffers 3I and the output buffers 3O that are included in the production process 1. Hereinafter, the number of dimensions of the input/output vector Zₖ and the input/output vector Wₖ will be referred to as “first number of dimensions”.

### Logical Model of Agent

Next, the logical model of the agent 11 will be described with reference to FIG. 3 The agent 11 illustrated in FIG. 3 corresponds to the k′th agent 11 out of the N agents 11.

As illustrated in FIG. 3, the agent 11 includes the first gain 20, an adder 21, a calculator 22, a second gain 23, and a third gain 24.

The first gain 20 receives input of the input/output vector Wₖ from the connector 15 as illustrated in FIG. 2. The input/output vector Wₖ is a vector of the number of dimensions M, which is to say, a first number of dimensions. The first gain 20 transforms the input/output vector Wₖ of the first number of dimensions into an input/output vector Wₖ′ of a second number of dimensions. The second number of dimensions is (mₖ+1). The second number of dimensions (mₖ+1) is determined by the number of elements that are an object of control input in the agent 11 of the first controller 12. In the present embodiment, the second number of dimensions (mₖ+1) is determined by number of dimensions (mₖ+1) of control input vector u^{(k)}, which will be described later. The first gain 20 is given by, for example, (mₖ+1)×M matrix. The third controller 14 controls the first gain 20 to transform the input/output vector Wₖ of the first number of dimensions into an input/output vector Wₖ′ of the second number of dimensions.

The adder 21 adds input/output vector Wₖ′ of the second dimensions that is output from the first gain 20, and vector p(k) (production vector) that is output from the second gain 23. Vector p^{(k)} is a vector of which the elements are a production rate of products in the production step 2. The number of dimensions of vector p^{(k)} is the second number of dimensions (mₖ+1). Vector p^{(k)} is given by Expression (11).

$$\begin{matrix}[ Math . 5 ] & \\ {p}^{( k )} = {( {p}_{I 1}^{( k )} , {p}_{I 2}^{( k )} , … , {p}_{Ii}^{( k )} , … , {p}_{{Im}_{k}}^{( k )} , {p}_{0}^{( k )} )}^{T} & ( 11 )\end{matrix}$$

In Expression (11), element p_{Ii}^{(k)} is the production rate of a part corresponding to element u_{Ii}^{(k)}, which will be described later. Element p_{Ii}^{(k)} is also written as “production rate p_{Ii}^{(k)}”. Element p_{O}^{(k)} is the production rate of a part corresponding to element u_{O}^{(k)}, which will be described later.

Calculation results of the adder 21 and the control input vector u^{(k)} are input to the calculator 22. The control input vector u^{(k)} is control input for achieving a target value for control in the agent 11. Each element of the control input vector u^{(k)} indicates deviation of current state quantity from the target value of control.

In the present embodiment, the control input vector u^{(k)} is control input for achieving a target value for a transportation rate of parts or products in the transporting steps 5. The control input vector u^{(k)} is given by Expression (12).

$$\begin{matrix}[ Math . 6 ] & \\ {u}^{( k )} = {( {u}_{I 1}^{( k )} , {u}_{I 2}^{( k )} , … , {u}_{Ii}^{( k )} , … , {u}_{{Im}_{k}}^{( k )} , {u}_{0}^{( k )} )}^{T} & ( 12 )\end{matrix}$$

Element u_{Ii}^{(k)} (where i is an integer that satisfies 1≤i≤mₖ) indicates deviation of state quantity from a target value of the transportation rate in the transporting step 5 of parts that are input to a relevant production step 2. The target value of the transportation rate for this part is a consensus reached between the agent 11 corresponding to the relevant production step 2 and the agent 11 corresponding to a production step 2 that is adjacent to that production step 2. This consensus is a point at which all production rates and transportation rates are in equilibrium.

Element u_{O}^{(k)} indicates the deviation of the state quantity from the target value of the transportation rate in the transporting step 5 of the parts or products that are output from the relevant production step 2. The target value of the transportation rate for the parts or products is a consensus reached between the agent 11 corresponding to the relevant production step 2 and the agent 11 corresponding to a production step 2 adjacent to that production step 2. This consensus is a point at which all production rates and transportation rates are in equilibrium.

The calculator 22 calculates a time derivative of a state vector x(k), based on the control input vector u^{(k)} and calculation results of the adder 21. The state vector x(k) represents a state of stock of parts in multiple input buffers 3I, and products in the output buffer 3O that are included in the production step 2 corresponding to the k′th agent 11. The state of stock of the parts or the products is, for example, the count in stock, volume in stock, or the like, of the parts or the products. The time derivative of the state vector x^{(k)} is given by Expression (13).

$$\begin{matrix}[ Math . 7 ] & \\ [ \begin{matrix}{\dot{x}}_{I 1}^{( k )} \\ ⋮ \\ {\dot{x}}_{I i}^{( k )} \\ ⋮ \\ {\dot{x}}_{{In}_{k}}^{( k )} \\ {\dot{x}}_{0}^{( k )}\end{matrix} ] = A [ \begin{matrix}{x}_{I 1}^{( k )} \\ ⋮ \\ {x}_{I i}^{( k )} \\ ⋮ \\ {x}_{{In}_{k}}^{( k )} \\ {x}_{0}^{( k )}\end{matrix} ] + Bu & ( 13 )\end{matrix}$$

In Expression (13), nₖ is the count of the state of stock of the input buffers 3I that are included in the production step 2.

In Expression (13), an element with the letters Inₖ subscripted to the letters x^{(k)} indicates the i′th (where i is an integer that satisfies 1≤i≤nₖ) state of stock among the states of stock of the nₖ count of input buffers 3I. Hereinafter, letters or an element in which the letters Inₖ are subscripted to the letters x^{(k)} will be written as “letters x^{(k)} Inₖ” or “element x^{(k)}Inₖ”.

In Expression (13), element x^{(k)}_{O} represents the state of stock of a product in the output buffer 3O that is included in the production step 2.

In Expression (13), an element with a dot above the letters x^{(k)} Inₖ is the time derivative of element x^{(k)} Inₖ. An element with a dot above the letters x^{(k)}_{O} is the time derivative of element x^{(k)}_{O}.

In Expression (13), matrix A is a matrix of (nₖ+1)×(nₖ+1). Matrix B is a matrix of (nₖ+1)×(mₖ+1). The components of matrix A and the components of matrix B are each determined by the elements of the production rate vector p^{(k)}, and so forth.

The number of dimensions (nₖ+1) of the state vector may be the same as the number of dimensions M of the input/output vector Wₖ, or may be different. For example, when the state of stock of a plurality of parts is defined regarding one input buffer 3I, the number of dimensions (nₖ+1) of the state vector and the number of dimensions M of the input/output vector Wₖ may differ. Hereinafter, the number of dimensions of the state vector will be referred to as “third number of dimensions”.

The state vector x^{(k)} is input to the second gain 23. The second gain 23 transforms the state vector x^{(k)}Of the third number of dimensions (nₖ+1) into vector p^{(k)} of the second number of dimensions (mₖ+1). The second gain 23 is, for example, a matrix of (mₖ+1)×(nₖ+1). Here, the first controller 12 controls the second gain 23 such that a consensus process regarding the input buffers 3I, a consensus process regarding the output buffer 3O, and a consensus process regarding the production rate, which will be described later, are satisfied. The first controller 12 controls the second gain 23, thereby controlling production volume of the product in the production step 2 corresponding to the agent 11.

The state vector x^{(k)} is input to the third gain 24. The second gain 23 transforms the state vector x^{(k)}Of the third number of dimensions (nₖ+1) into the input/output vector Zₖ of the first number of dimensions M. The third gain 24 is, for example, a matrix of M×(nₖ+1). Here, the second controller 13 controls the third gain 24 such that the consensus process regarding the input buffers 3I, the consensus process regarding the output buffer 3O, and the consensus process regarding the production rate, which will be described later, are satisfied. The second controller 13 controls the third gain 24 to control the transport volume of the product in the transporting step 5.

The consensus process regarding the input buffers 3I is given by Expression (14) when the agent 11 corresponds to the initial stage production step 2. The consensus process regarding the input buffers 3I is given by Expression (15) when the agent 11 corresponds to a production step 2 other than the initial stage.

$$\begin{matrix}[ Math . 8 ] & \\ {x}_{Ii} ( t + 1 ) = {x}_{Ii} ( t ) - {p}^{i} ( t ) + {\sum }_{k ∈ {N}_{i}} {u}^{k \to i} ( t ) + {Ψ}^{i} ( t ) & ( 14 )\end{matrix}$$

$$\begin{matrix}[ Math . 9 ] & \\ {x}_{Ii} ( t + 1 ) = {x}_{Ii} ( t ) - {p}^{i} ( t ) + {\sum }_{k ∈ {N}_{i}} {u}^{k \to i} ( t ) & ( 15 )\end{matrix}$$

In Expression (14), ψⁱ(t) represents a delivery rate per unit time for parts that are supplied from outside the production process 1 to the i′th input buffer 3I among the nₖ input buffers 3I that are included in the production step 2. This ψⁱ(t) may be treated as a time-independent constant, i.e., ψⁱ.

In Expressions (14) and (15), element x_{Ii}(t+1) is element x_{Ii} at time (t+1). Element x_{Ii}(t) is element x_{Ii} at time (t).

In Expressions (14) and (15), element pⁱ is the production rate of parts in the production step 2. Element pⁱ gives a consumption rate of the parts at the i′th input buffer 3I among the nₖ input buffers 3I.

In Expressions (14) and (15), element u^{k→i}(t) indicates the delivery rate of parts supplied from an upstream production step 2 that is identified by the subscript k, to the i′th input buffer 3I of the relevant production step 2 at time (t). Set Nᵢ is a set of the production steps 2 from which the parts are transported to the i′th input buffer 3I.

The consensus process regarding the output buffer 3O is given by Expression (16) when the agent 11 corresponds to the final stage production step 2. The consensus process regarding the output buffer 3O is given by Expression (17) when the agent 11 corresponds to a production step 2 other than the final stage production step 2.

$$\begin{matrix}[ Math . 10 ] & \\ {x}_{O} ( t + 1 ) = {x}_{O} ( t ) + {\sum }_{i ∈ {N}_{Ii}} {p}^{i} ( t ) - {\sum }_{ki ∈ {N}_{ki}} {u}^{k \to i} ( t ) - Φ ( t ) & ( 16 )\end{matrix}$$

$$\begin{matrix}[ Math . 11 ] & \\ {x}_{O} ( t + 1 ) = {x}_{O} ( t ) + {\sum }_{i ∈ {N}_{Ii}} {p}^{i} ( t ) - {\sum }_{ki ∈ {N}_{ki}} {u}^{o \to ki} ( t ) & ( 17 )\end{matrix}$$

In Expression (16), Φ(t) represents a conveyance rate of finished products to outside of the production process 1. This Φ(t) may be treated as a time-independent constant, i.e., Φ. The Φ, and the ψⁱ in Expression (14), are set in order to maintain the balance of stock in production process 1 in a steady state.

In Expression (16) and Expression (17), element x_{O}(t+1) is element x_{O} at time (t+1). Element x_{O}(t) is element x_{O} at time (t).

In Expression (16) and Expression (17), element u^{O→ki}(t) represents the transportation rate of parts at time (t) from the output buffer 3O to the i′th input buffer 3I of the downstream production step 2 that is identified by the subscript k. The set Nₖᵢ is a set of multiple input buffers 3I that are included in downstream production steps 2 identified by the subscript k.

Here, it is assumed that the parts that are supplied to the i′th input buffer 3I are being consumed at a production rate p_{Ii}^{(k)} and becoming new parts. Accordingly, in Expression (16) and Expression (17), the total value of the consumption rate, i.e., the production rate p_{Ii}^{(k)}, in the set N_{Ii} is added to element x_{O}(t). The set N_{Ii} is a set of the input buffers 3I that are included in the production step 2.

The consensus process regarding the production rate is given by Expression (18).

$$\begin{matrix}[ Math . 12 ] & \\ {p}^{i} = - H ( {x}_{O} - {\sum }_{i ∈ {N}_{Ii}} {x}_{Ii} ) & ( 18 )\end{matrix}$$

In Expression (18), H (>0) is feedback gain.

In this way, the agent 11 according to the present embodiment includes the first gain 20 that transforms the input/output vector Wₖ of the first number of dimensions into the input/output vector Wₖ′ of a second number of dimensions. According to such a configuration, one production step 2 can be handled by batch processing, which will be described below. In other words, one production step 2 can be handled as one agent 11.

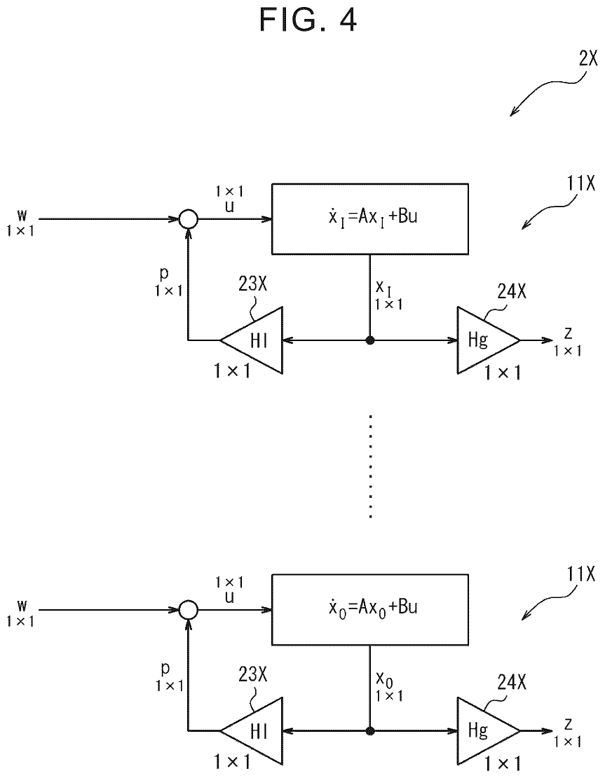

As a comparative example, a configuration 2X such as that illustrated in FIG. 4 will be considered. One configuration 2X corresponds to one production step 2 such as illustrated in FIG. 1. The configuration 2X does not include the first gain 20. Accordingly, in the comparative example, each element of the input/output vector Wₖ has to be treated as a scalar. In the comparative example, since each element of the input/output vector Wₖ has to be treated as a scalar, an agent 11X having a second gain 23X and a third gain 24X has to be provided for each element of the input/output vector Wₖ. That is to say, in the comparative example, one production step 2 has to be handled by a plurality of agents 11X. An assumption will be made here that the production steps 2A and 2B each include one input buffer 3I and one output buffer 3O, for the sake of description. In this case, in the comparative example, one production step 2A has to be handled by two agents 11X, and one production process 2B has to be handled by two agents 11X, as illustrated in FIG. 5. Note that in FIG. 5, scalars Z1 and W1 correspond to the input buffer 3I of the production step 2A, and scalars Z2 and W2 correspond to the output buffer 3O of the production step 2A. Also, scalars Z3 and W3 correspond to the input buffer 3I of the production step 2B, and scalars ZA and W4 correspond to the output buffer 3O of the production step 2B. In this comparative example, the input/output vector Z is given by scalars Z1 through Z4, and the input/output vector W is given by scalars W1 through W4. In the comparative example, the Laplacian matrix K of the connector 15X is given by Expression (8).

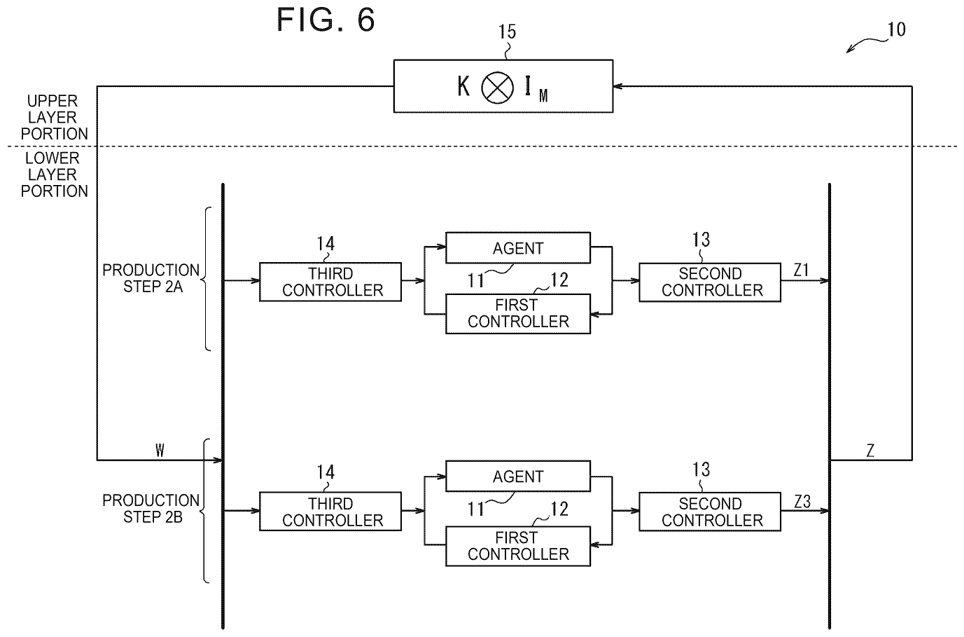

In contrast to such a comparative example, the agent 11 according to the present embodiment includes the first gain 20 that transforms the input/output vector W of the first number of dimensions into an input/output vector W′ of the second number of dimensions. According to this configuration, one production step 2 can be handled by batch processing. In other words, one production step 2 can be handled as one agent 11. In the above-described example of the production steps 2A and 2B, the production step 2A can be handled by one agent 11, and the production step 2B can be handled by one agent 11, as illustrated in FIG. 6.

Also, in the comparative example, the agent 11X multiplies scalar XIi by the third gain 24X, following which the connectivity relation among the multiple production steps 2 is provided by the transporting step 5 at the connector 15X. Therefore, when the first controller 12 and the second controller 13 respectively perform control of the second gain 23X and the third gain 24X based on the above-described consensus process, this connectivity relation has to be taken into consideration. Also, in the comparative example, after multiplication by the second gain 23X and the third gain 24X, delay in information in the consensus process cannot be taken into consideration.

In contrast to such a comparative example, the agent 11 according to the present embodiment handles the input/output vector W in which a connectivity relation among multiple production steps 2 by the transporting step 5 is provided. According to such a configuration, the connectivity relation is taken into consideration in the control, based on the above-described consensus process. This enables information delays in the consensus process to be taken into consideration.

Furthermore, the multiagent system 10 according to the present embodiment includes multiple first controllers 12 that respectively control the multiple agents 11, and multiple second controllers 13 that perform cooperative control among the multiple agents 11. That is to say, the multiagent system 10 employs distributed control. According to this configuration, the agents 11 can each be individually controlled by the first controllers 12 while the entire system can be controlled by the multiple second controllers 13. As a result, the multiagent system 10 can reduce calculation costs as compared to a case in which centralized control is employed, in which multiple agents 11 are controlled by one controller.

Thus, according to the present disclosure, a multiagent system can be designed such that the multiagent system is improved.

### Simulation Results

The inventors conducted simulation to confirm the effectiveness of the multiagent system according to the present disclosure. First, simulation conditions will be described.

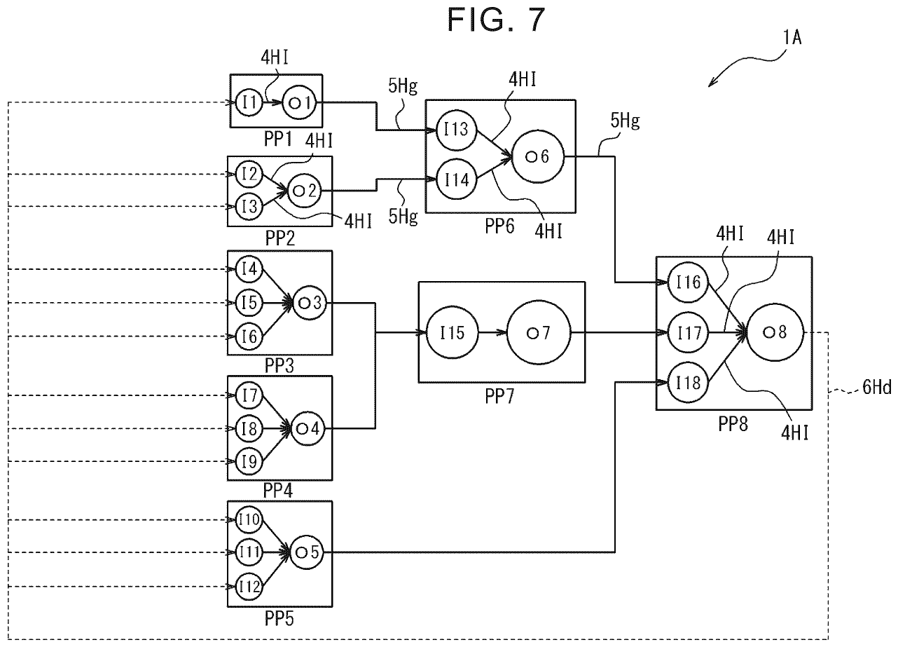

FIG. 7 illustrates a flow of production process 1A that is used in the simulation. The production process 1A includes production steps PP1, PP2, PP3, PP4, PP5, PP6, PP7, and PP8. In FIG. 7, lines 4HI indicate flow of production volume of the product in the production steps. Lines 5Hg indicate the actual transport volume of the product between each production step. Lines 6Hd indicate flow of information from the output of the final stage production step in the production process 1A to the inputs of the initial stage production steps. The lines 6Hd may represent any flow of information regarding the production process. The lines 6Hd may indicate just the flow of information.

The production steps PP1 to PP8 have the same or similar configurations as the production steps 2. The production step PP1 includes an input buffer I1 and an output buffer O1. The production step PP2 includes input buffers I2 and I3 and an output buffer O2.

The production step PP3 includes input buffers I4, I5, and I6, and an output buffer O3. The production step PP4 includes input buffers I7, I8, and I9, and an output buffer O4. The production step PP5 includes input buffers I10, I11, and I12, and an output buffer O5. The production step PP6 includes input buffers I13 and I14 and an output buffer O6. The production step PP7 includes an input buffer I15 and an output buffer O7. The production step PP8 includes input buffers I16, I17, and I18, and an output buffer O8.

The input buffers I1 to I18 have configurations that are the same as or similar to that of the input buffers 3I. The output buffers O1 to O8 have configurations that are the same as or similar to that of the output buffers 3O.

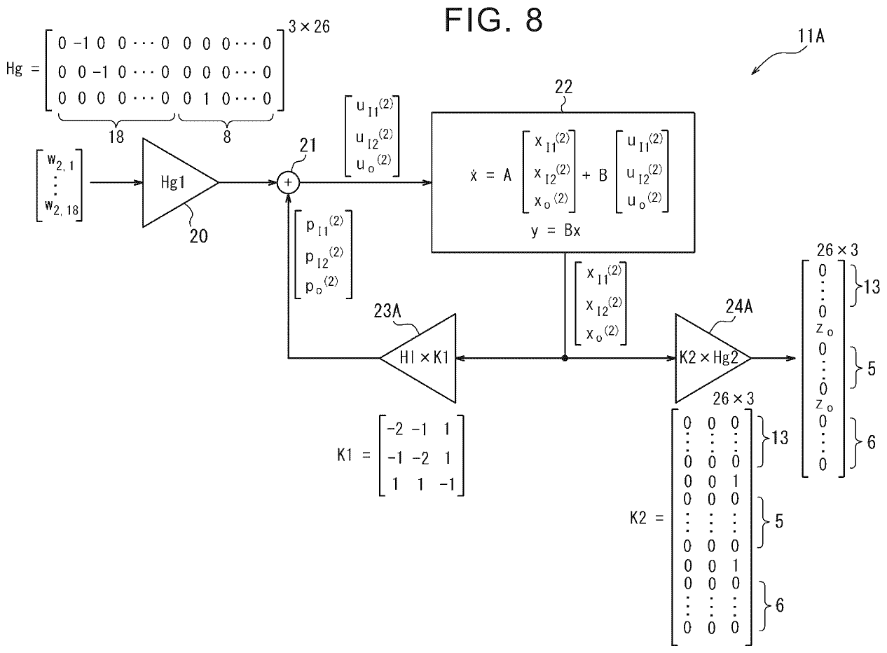

FIG. 8 illustrates a production step PP2 in the logical model of agent 11A that is used in the simulation. The production step PP2 is an agent in which k=2. The agent 11A includes the first gain 20, the adder 21, the calculator 22, a second gain 23A, and a third gain 24A. Adjacent to these elements are written the matrices that were employed for these elements. The state vector x^{(k)}Of the calculator 22 is given by Expression (19).

$$\begin{matrix}[ Math . 13 ] & \\ x = [ \begin{matrix}{x}_{I 1} , & {x}_{I 2} , & … , & {x}_{{In}_{k}} , & {x}_{o}\end{matrix} ] & ( 19 )\end{matrix}$$

The state vector x^{(k)}Of the calculator 22 indicates the state of stock of parts in the input buffers and products in the output buffers included in the production steps PP1 to PP8, as illustrated in FIG. 7. The second gain 23A has a configuration that is the same as or similar to that of the second gain 23 that is illustrated in FIG. 3. The third gain 24A has a configuration that is the same as or similar to that of the third gain 24 that is illustrated in FIG. 3.

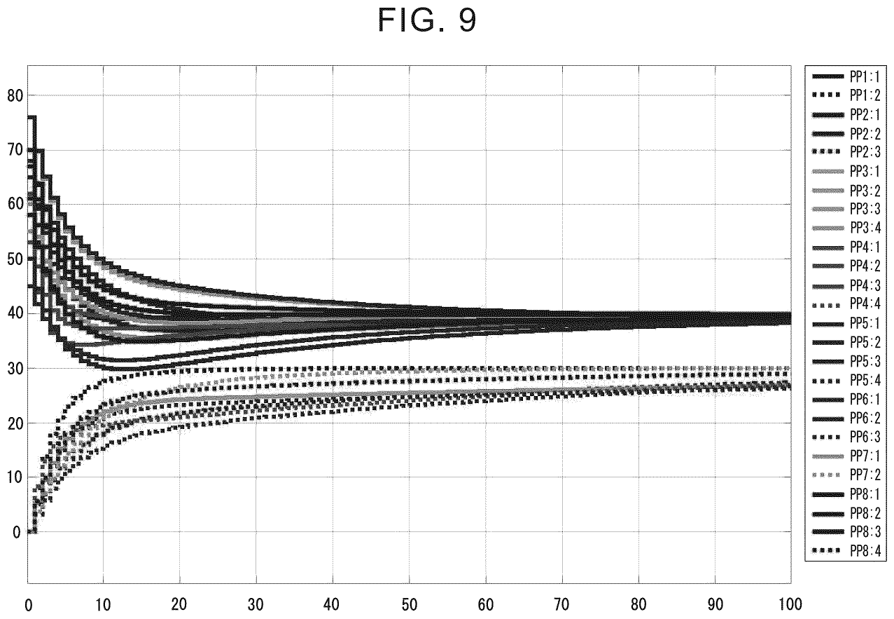

FIG. 9 shows simulation results. In FIG. 9, the horizontal axis indicates time (time steps). The vertical axis indicates the count of parts or products in stock in the buffer. The count of stock is an example of the state of stock. Here, labels in FIG. 9 are written as “PPq:r”. In this case, q corresponds to production steps PP1 to PP8. The maximum value r indicates the count of products in stock in the output buffer of the production step that is indicated by q. Any value of r other than the maximum value indicates the count of parts in stock in the r′th input buffer of the production step that is indicated by q. The r′th number corresponds to the order of the signs by which the input buffers are denoted in FIG. 7. For example, in the case of labels PP8:1, PP8:2, PP8:3, and PP8:4, the label PP8:4 indicates the counts of products in stock in the output buffer O8 of the production step PP8. Labels PP8:1 to PP8:3 indicate the counts of parts in stock in the input buffers I16 to I18 of the production step PP8, respectively.

As shown in FIG. 9, the count of parts in stock in the input buffers and the count of parts in stock of products in the output buffers in the production steps PP1 to PP8 converge. From this result, it can be seen that even in a case in which different agents are included in the production process 1A, the state of stock of parts or products in the input buffers and output buffers converges to a consensus.

While the present disclosure has been described based on the drawings and examples, it should be noted that those skilled in the art may make various modifications and alterations based on the present disclosure. Accordingly, it should be noted that these variations and modifications are included within the scope of the present disclosure. For example, the functions and so forth contained in each component or each step can be rearranged so as not to cause logical inconsistencies, and multiple components, steps, and so forth, can be combined into one, or divided.

What is claimed is:

1. A multiagent system, comprising:
a plurality of agents;
a plurality of first controllers that controls the agents, respectively; and
a plurality of second controllers that performs cooperative control among the agents, wherein
in the multiagent system in which number of dimensions of an input/output vector that is input to the agent is a first number of dimensions,
the agents include a first gain that transforms the input/output vector of the first number of dimensions into an input/output vector of a second number of dimensions,
the first number of dimensions is a total count of a plurality of buffers that is included in a production process to which the multiagent system is applied, and
the second number of dimensions is determined by a count of elements that are objects of control input by the agents of the first controllers.

2. The multiagent system according to claim 1, wherein:
the production process includes a plurality of production steps; and
the agents correspond to the production steps, respectively.

3. The multiagent system according to claim 2, wherein:
the agents further include a second gain for transforming a state vector of a third number of dimensions into a production vector of the second number of dimensions;
the state vector of the third number of dimensions indicates a state of stock of parts in a plurality of input buffers and products in output buffers that are included in the production steps corresponding to the agents;
the production vector of the second number of dimensions is a vector of which an element is a production rate of the product in the production step; and
the first controllers control production volume of the products in the production steps by controlling the second gain.

4. The multiagent system according to claim 3, wherein:
the agents further include a third gain for transforming the state vector of the third number of dimensions into the input/output vector of the first number of dimensions; and
the second controllers control transport volume of the products in the production steps by controlling the third gain.
